(19) United States
(12) Patent Application Publication
(10) Pub. No.: US 2013/0343398 A1
(43) Pub. Date: Dec. 26, 2013

(54) PACKET-BASED COMMUNICATION SYSTEM WITH TRAFFIC PRIORITIZATION

(71) Applicant: Octavian Sarca, Aurora (CA)

(72) Inventor: Octavian Sarca, Aurora (CA)

(73) Assignee: Redline Communications Inc., Markham (CA)

(21) Appl. No.: 13/528,274

(22) Filed: Jun. 20, 2012

(51) Int. Cl. H04L 12/56

(52) U.S. Cl. 370/412

(57) ABSTRACT

A method is provided for handling packets at a queuing point in a packet-based communication system that handles the packets, when each of the packets is assigned one of a plurality of service priorities. At least one discard threshold is assigned to each of the service priorities, and when one of the packets is delivered to the queuing point, a count of the total number of packets or bytes stored in a queue at the queuing point is maintained. That count is compared with a selected discard threshold associated with the service priority assigned to the packet delivered to the queuing point, and that packet is selectively discarded if the count reaches the selected discard threshold. Packets having different service priorities may be stored in the queue.

### FIELD OF THE INVENTION

The present invention relates to packet-based communication systems and, more particularly, to traffic prioritization in such systems.

### BACKGROUND OF THE INVENTION

Packet-based communication standards, e.g., IEEE 802.1p, offer the ability to specify several service priorities which can be interpreted in different way (either discard or delay priority or a combination thereof). Different standards or networking layers also offer the ability to define service priorities in the same way.

Because of the multiple queuing points in the network, resulting from speed mismatch between incoming and outgoing link speeds or merging of traffic from multiple input links into an outgoing link.

In order to support the service priorities of the standards, several queuing systems are generally combined with complex scheduling algorithms (e.g., WFQ, WRR, hierarchical weighted scheduling).

These scheduling systems are complex to implement, costly and difficult to engineer (e.g., weights of WFQ systems) and more difficult to implement as the speed of the links increases. For some applications a simpler system that is easy to engineer is required.

### SUMMARY OF THE INVENTION

In one embodiment, a method is provided for handling byte-containing packets at a queuing point in a packet-based communication system that handles the packets, when each of the packets is assigned one of a plurality of service priorities. At least one discard threshold is assigned to each of the service priorities, and when one of the packets is delivered to the queuing point, a count of the total number of packets or bytes stored in a queue at the queuing point is maintained. That count is compared with a selected discard threshold associated with the service priority assigned to the packet delivered to the queuing point, and that packet is selectively discarded if the count reaches the selected discard threshold. Packets having different service priorities may be stored in the queue.

A packet delivered to the queuing point is preferably pre-processed prior to the comparing step, and post-processed after the comparing step. The pre-processing may include receiving one of the packets at the queuing point, and the post-processing may include inserting that packet into the tail end of the queue. Alternatively, the pre-processing includes removing said one packet from the head end of said queue, and said post-processing includes transmitting the removed packet on a transmission line. Combinations of the two types of pre-processing and post-processing may also be used. For example, packets assigned a first service priority may be pre-processed by receiving one of the packets at the queuing point, and post-processed by inserting that packet into the tail end of the queue, and packets having a second service priority may be pre-processed by removing said one packet from the head end of said queue, and post-processed by transmitting the removed packet on a transmission line.

In one implementation, first and second discard thresholds are assigned to a service priority, and a packet assigned that service priority is discarded before insertion into the tail end of the queue when the count reaches the first discard threshold, and before transmission from the head end of the queue when the count reaches the second discard threshold. Random early dropping threshold ranges are assigned to different predetermined discard thresholds to increase the probability of discarding packets assigned a selected service priority when the count reaches the discard threshold for the selected service priority. The comparing may be done before the packet is admitted to the queue, and the discarding of the packet is effected before the packet is admitted to the tail end of the queue. Or the comparing may be done after the packet is admitted to the queue, and the discarding effected before the packet is transmitted from the head end of the queue.

In another implementation, at least one discard threshold is assigned to each of the service priorities, and a count is maintained of the total number of packets of each service priority stored in the queue. The count associated with the service priority assigned to a packet is compared with a selected discard threshold associated with that service priority, and that packet is selectively discarded if the count reaches the selected discard threshold.

### BRIEF DESCRIPTION OF THE DRAWINGS

The invention will be better understood from the following description of preferred embodiments together with reference to the accompanying drawings, in which:

FIG. 1 is a diagrammatic illustration of multiple queues for packets having different service priorities in a packet-based communication system.

FIG. 2 is a diagrammatic illustration of a single queue for packets having different service priorities with different discard thresholds for the different service priorities, in a packet-based communication system.

FIG. 3 is a diagrammatic illustration of multiple queues for packets having different service priorities with different discard thresholds for the different service priorities, in a packet-based communication system.

### DETAILED DESCRIPTION OF ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

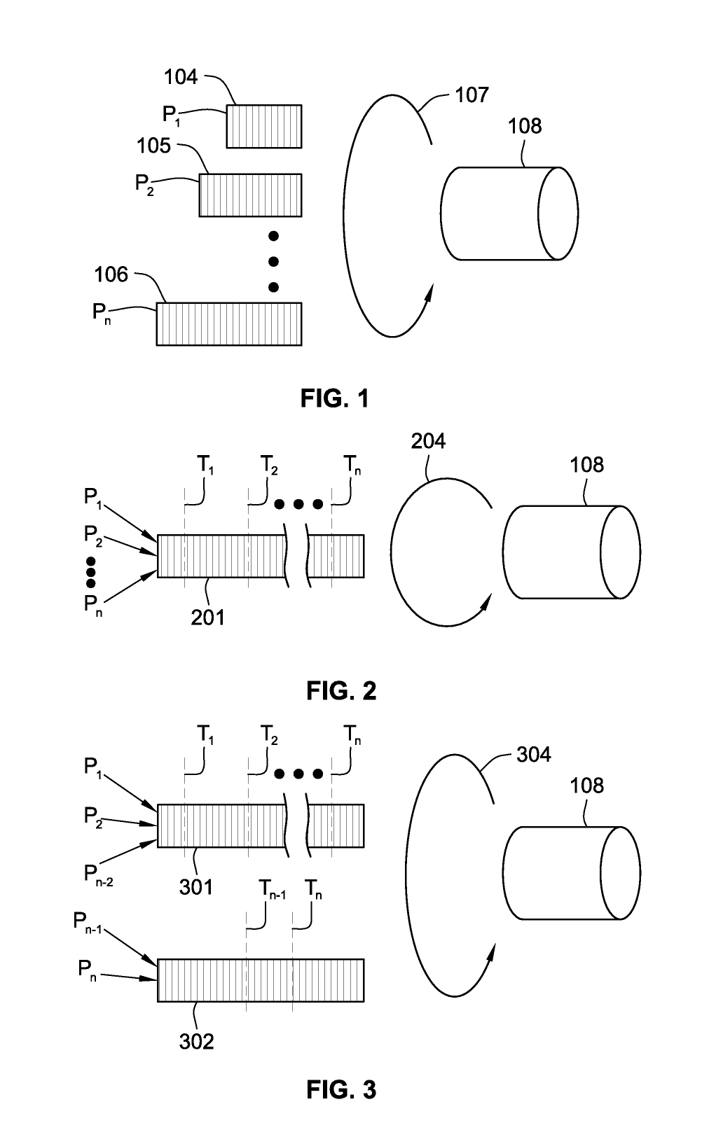

FIG. 1 illustrates a known type of multi-queue scheduling system for use at a queuing point in a packet-based communication system. As depicted in FIG. 1, packets of several different service priorities 101, 102 and 103 are merged into different queues 104, 105 and 106, respectively. In this case, service 101 is of higher priority than service 102, and service 102 is of higher priority than service 103. A scheduler 107 is implemented to select the next packet to be transmitted on a link 108 of the communication system, by servicing the queues in such a way as to meet the delay, jitter and loss requirements specified for each of the services. The scheduler 107 needs to be implemented using weighted round robin (WRR) or weighted fair queuing (WFQ) to avoid starvation of lower priority queues. Hierarchies of schedulers can also be implemented. In this case a higher weight would be given to the highest service priority 101, and the weight lowers as the service priority lowers. The concept of service priority includes several performance aspects such as delay, delay variation and loss targets. Therefore, depending on the setting of these targets, a given priority is provided to a service.

FIG. 2 illustrates a scheduling system in which a single queue 201 is used to merge packets having all the difference service priorities 101, 102 and 103. Again, service priority 101 is of higher service priority than service priority 102, which is higher than service priority 103. In this case, the higher service priorities might not be defined as having strict delay and jitter requirements, or if they do the link speed may be fast enough that the delay and jitter requirements will be met no matter how far down the queue a packet is stored upon arrival. In this embodiment, one or more thresholds are used to discard the traffic of lower priority, such that higher priority traffic will find room in the queue upon arrival. In this case, the scheduler may be a simple FIFO scheduler selecting the packet at the top of the queue for transmission on the link 108. In the system depicted in FIG. 2, there is one discard threshold for each of the service priorities 201, 202 and 203, but in other embodiments there could be as many discard thresholds as there are services to support, or two or more services could be mapped to a single discard threshold.

In another embodiment, one or more random early dropping (RED) thresholds can be associated with each or some of the discard thresholds for the service priorities 201, 202 and 203. In this case, the probability of dropping a packet of service priority n increases once the random dropping threshold associated with the discard threshold for service priority n is reached. For example, assume a queue capacity of 100 packets, and a first discard threshold 201 at capacity of 100 packets, a second discard threshold 202 at capacity of 75 packets, and a third threshold discard 203 at capacity of 10 packets. Then service priority-3 packets are all discarded when the count of packets in the queue exceeds the third threshold 203 of 10 packets, but only some percentage (e.g., 50%) of the service priority-2 packets are randomly discarded when the count of packets in the queue exceeds the third threshold 203 of 10 packets. However, all the service priority-2 packets are discarded when the count of packets in the queue exceeds the service priority-2 threshold 203 of 75 packets. None of the service priority-1 packets are discarded when the second threshold 202 or the third threshold 203 is exceeded. This guarantees that service priority-1 packets will have dedicated access to some proportion of the queue.

In one embodiment, the RED thresholds ranges are overlapping such that the drop priority for one service is overlapping with the drop priority of a lower or higher priority service. In another case, the RED threshold ranges do not overlap, such that for a given queue depth only one priority class has a drop probability other than 0 or 1.

Head-of-the-line dropping (head dropping) may be performed on packets from lower priority services when the queue size reaches a given threshold. Head dropping means to discard the packet that is at the head of the queue, which should otherwise be transmitted on the link next. This way, the queue size is reduced, but no bandwidth is consumed on the link, making it available for higher priority services.

In another embodiment, a combination of head and tail dropping can be used where each service priority is assigned to one mechanism. A further enhancement uses two thresholds per service, tail dropping is used when the first threshold is reached and head dropping is used when the second threshold is reached. For example, if a service of higher priority and a service of lower priority share the queue, then the service of higher priority would see its packet discarded when the packet enters the queue and the queue size reaches a first threshold, typically the full size of the buffer. For the service of lower priority, the decision of dropping the packet based on the queue size is made when de-queuing the packet and preparing it for transmission (before wasting transmission bandwidth). In this case, the queue size is compared to a second threshold when the packet of lower priority is de-queued. The decision to drop or transmit the packet is based on whether the queue size is above or below the second threshold. This way, the application layer is notified earlier that there is congestion in the queue and can adapt (e.g., TCP/IP) its transmission rate accordingly.

As another example, a three-priority system may use combined head and tail dropping. A queue capable of holding 200 packets may be used to carry packets of service priorities 1, 2 and 3, where priority 1 is the highest and priority 3 is the lowest. If a packet from priority 1 service arrives and there is room in the queue, the packet is queued and will be transmitted when it reaches the head of the queue. If a packet of service priority 2 arrives and the queue size is above a second threshold, such as 150 packets, then the service priority-2 packet is discarded; otherwise it is queued for transmission. If a packet of service priority 3 arrives and there is space in the queue, the packet is queued, but when that packet arrives at the head of the queue and it is ready for transmission, if the queue size exceeds a third threshold it is discarded instead of being transmitted. The queue size can be calculated based on the number of packets or based on the number or bytes.

In yet another embodiment, counts are used to keep track of how many packets of each service priority are stored in the queue. Packets of a given priority are discarded when the count for that priority exceeds a predetermined value. Random early discard can also be applied to the count. A combination of count and queue size (total count) can also be used to determine whether a packet is to be dropped or not. The count could be calculated based on the number of packets or based on the number or bytes.

FIG. 3 illustrates a scheduling system in which a high-priority queue 301 and a low-priority queue 302 are used with a simple exhaustive round-robin scheduler 304 implemented to select the next packet to transmit on the link 108. Exhaustive round-robin is a cost effective simple algorithm that can be implemented at high speed. In this case, delay sensitive services are put in the high priority queue 301, and the other services are mapped to the lower priority queue 302. The thresholding systems 201, 202, 305, 306 and 307 described above can be implemented on each queue.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

1. A method of handling byte-containing packets at a queuing point in a packet-based communication system that handles said packets, each of which is assigned one of a plurality of service priorities, said method comprising
assigning at least one discard threshold to each of said service priorities,
delivering one of said packets to said queuing point,
maintaining a count of the total number of packets or bytes stored in a queue at said queuing point,
comparing said count with a selected discard threshold associated with the service priority assigned to said one packet delivered to said queuing point, and
selectively discarding said one packet if said count reaches said selected discard threshold.

2. The method of claim 1 in which packets having different service priorities are stored in said queue.

3. The method of claim 1 in which said one packet is pre-processed prior to said comparing, and post-processed after said comparing if said packet is not discarded.

4. The method of claim 3 in which said pre-processing includes receiving said one packet, and said post-processing includes inserting said one packet into the tail end of said queue.

5. The method of claim 3 in which said pre-processing includes removing said one packet from the head end of said queue, and said post-processing includes transmitting the removed packet on a transmission line.

6. The method of claim 3 which includes first pre-processing and post-processing according to claim 4, and second pre-processing and post-processing according to claim 5.

7. The method of claim 3 in which packets assigned a first service priority are pre-processed and post-processed according to claim 4, and packets having a second service priority are pre-processed and post-processed according to claim 5.

8. The method of claim 3 in which first and second discard thresholds are assigned to a service priority, and a packet assigned that service priority is discarded before insertion into the tail end of said queue when said count reaches said first discard threshold, and before transmission from the head end of said queue when said count reaches said second discard threshold.

9. The method of claim 1 which includes assigning random early dropping threshold ranges to different predetermined discard thresholds to increase the probability of discarding packets assigned a selected service priority when said count reaches the discard threshold for said selected service priority.

10. The method of claim 1 in which said comparing is done before said one packet is admitted to said queue, and the discarding of said one packet is effected before said one packet is admitted to the tail end of said queue.

11. The method of claim 1 in which said comparing is done after said one packet is admitted to said queue, and said discarding is effected before said one packet is transmitted from the head end of said queue.

12. A method of handling byte-containing packets at a queuing point in a packet-based communication system that handles said packets, each of which is assigned one of a plurality of service priorities, said method comprising
assigning at least one discard threshold to each of said service priorities,
delivering one of said packets to said queuing point,
maintaining a count of the total number of packets or bytes of each service priority stored in a queue at said queuing point,
comparing said count associated with the service priority assigned to said one packet with a selected discard threshold associated with the service priority assigned to said one packet, and
selectively discarding said one packet if said count reaches said selected discard threshold.
